(19) United States
(12) Patent Application Publication
(10) Pub. No.: US 2002/0043273 A1
(43) Pub. Date: Apr. 18, 2002

(54) Method of removing hazardous insulation material

(75) Inventor: Alexander S. Chau, Edmonton (CA)

Correspondence Address: Dennison Associates, 133 Richmond Street West, Suite 301, Toronto, ON, M5H 2L7, CA

(73) Assignee: ALUMA ENTERPRISES INC.

(21) Appl. No.: 09/911,699

(22) Filed: Jul. 25, 2001

(30) Foreign Application Priority Data
Jul. 27, 2000 (CA) 2,314629

(51) Int. Cl. B08B 3/02

(52) U.S. Cl. 134/18; 134/26; 134/36

(57) ABSTRACT

A method of removing hazardous insulation material advantageously uses a glove bag with a large open mouth which is secured to a wall portion exterior to the insulation to be removed. The wall portion and the glove bag collectively enclose and isolate the insulation to be removed. The insulation is removed, the border of exposed insulation is sealed, and the glove bag properly removed. The method is effective and time efficient and is suitable for many applications, including removal of asbestos and silica insulation.

### FIELD OF THE INVENTION

The present invention relates to a method of removing hazardous insulation material from a limited region of a large surface and in particular, relates to the removal of asbestos insulation.

### BACKGROUND OF THE INVENTION

Removal of asbestos insulation from pipes and other structures which are easily enclosed are well known. Specialized glove bags are manufactured which can be placed about a limited portion of a pipe, taped to the pipe or otherwise secured to the pipe in a manner to provide a seal with the pipe being exposed to the interior of the glove bag. The insulation can then be appropriately cut and placed in the bottom of the glove bag and any asbestos fibers are retained within the glove bag. It is also known to use wetting agents to continually wet the asbestos to reduce asbestos particles in the air. Specialized glove bags are manufactured for use with straight pipe sections, elbow sections and “T” joints.

Although the glove bags have worked satisfactorily with respect to elongate and exposed members, such as insulated pipes, there are a host of large structures which cannot be wrapped or enclosed in this manner such that a portion of the structure is surrounded by the glove bag. In these applications, it is necessary to construct temporary walls (hoarding) and provide a closed environment to facilitate the removal of asbestos or other hazardous materials. The workers all wear special protective apparel and protective breathing apparatus. The closed environment is typically under-negative pressure such that any leakage of air is into the enclosure as opposed to out of the enclosure.

This is a costly procedure and considerable caution is necessary due to the possible danger of leakage. For these reasons, it is expensive and time consuming to repair insulated structures and in particular, to repair a portion of a generally planar insulated structure. Furthermore, the structure to be repaired is out of service for an extended period.

The present invention seeks to provide a method which can be used on a large structure where a portion of the insulation on the wall structure is to be removed and where it is difficult to enclose the pertinent section of the structure in a glove bag.

### SUMMARY OF THE INVENTION

A method of removing a portion of an insulated wall according to the present invention comprises placing the necessary tools within a glove bag having a large open mouth, securing the glove bag to the wall such that the open mouth is attached to the wall and surrounds and is spaced outwardly of the periphery portion of the insulation material to be removed, wetting the portion of the insulation material to be removed, cutting and removing the portion of the insulation material, such that the removed insulation is located in a lower part of the bag, sealing any exposed edges of the remaining insulation, cleaning the area of the wall within the glove bag to remove any loose insulation material that remains, sealing the glove bag below the mouth, and cutting the bag free of the sealed portion of the bag for further processing and removing the remaining portion of the glove bag from the wall.

According to an aspect of the invention, the method includes the steps of pulling one of the gloves inside out and placing any tools therein and sealing the inside out glove to isolate the tools in the glove below the seal and cutting through the seal to maintain the seal on the glove and on the portion of the bag that remains.

In yet a further aspect of the invention, the method includes a water absorbent material within the glove bag at the edge of the lower seal. This is to reduce the amount of water which could damage the lower seal.

In yet a further aspect of the invention, the glove bag is sealed to the asbestos wall by an adhesive adhering the bag to the wall and tape on the outside of the bag at the mouth in contact with the wall to provide an outside seal of the bag to the wall.

### BRIEF DESCRIPTION OF THE DRAWINGS

Preferred embodiments of the invention are shown in the drawings, wherein:

FIG. 1 is a partial front view of a boiler wall with a glove bag secured about a portion of the wall to be removed;

FIG. 2 is a schematic view of an injector used to inject a wetting agent into pressurized water to form a dampening mist which is sprayed on the asbestos wall;

FIG. 3 is a schematic view of a preferred injector for combining a wetting agent with a pressurized water flow; and

FIG. 4 is a schematic view of a modified amended water injection arrangement.

### DETAILED DESCRIPTION OF THE PREFERRED EMBODIMENTS

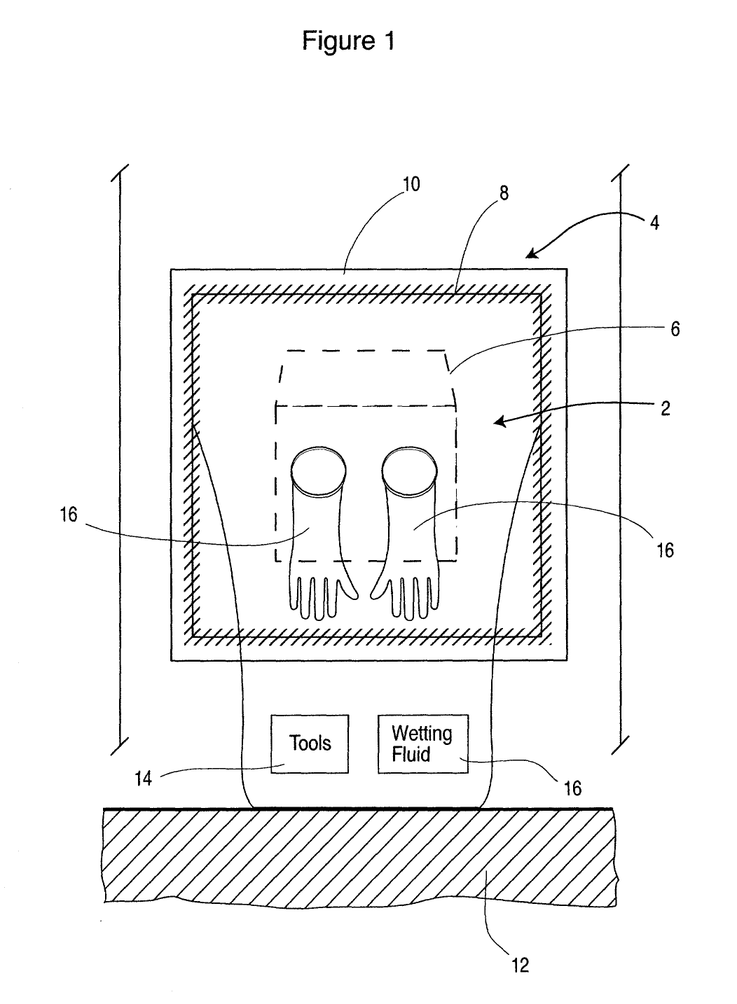

FIG. 1 shows part of a large boiler wall 4 which is typically a steel structure with an outer insulating layer which in many cases is made of asbestos. From time to time it is necessary to repair a portion of the boiler wall, insulated tank wall, process operating equipment, insulated building walls, or other insulated structures. For example, in the case of a boiler wall, there could be control valves or pipes passing through the wall which need replacement or there could be control equipment on the outside of the wall which is in need of replacement. Other reasons can include repair to the wall itself or perhaps the insulation on the outside of the structure is questionable in a limited area, and should be removed and replaced. This approach is particularly useful for removal of small areas up to about 50 square feet.

In FIG. 1, a portion 6 of asbestos insulation is to be removed and a large opened mouth glove bag 2 has been secured to the asbestos wall by means of an adhesive seal 8 between the mouth of the glove bag and the asbestos insulation. In addition, an outer tape seal 10 is provided by a duct tape or other suitable tape which engages both the asbestos wall and the outer edge of the glove bag. In this way, the boiler wall 4 and the opened mouth glove bag, define an essentially closed environment about the portion 6 of the asbestos insulation which is to be removed.

The operator is positioned exterior to the glove bag and uses the gloves 16 to use any of the tools 14 within the glove bag to remove the portion 6 of the asbestos insulation. Typically this area is first marked on the wall and then the glove bag is secured about the portion to be removed. Any necessary tools 14 and wetting fluid such as water or amended water, can be provided in the bag prior to securement. In addition, a water absorption material can also be positioned in the bag above the bottom seal to the wall to protect the seal from damage.

The operator initially wets the portion 6 to be removed and continues to wet this area throughout the removal process. This reduces airborne contaminants. For some applications, it may be preferred to introduce the wetting fluid through a sealed port in the glove bag with the wetting fluid supply being exterior to the glove bag. The removed asbestos insulation is carefully placed in the bottom of the glove bag to avoid increasing any air borne asbestos fibers or particles.

With this arrangement, it is possible to effectively seal off a large flat or curved surface, which is not easily isolated by means of a glove bag surrounding the area. The method uses part of the structure itself to form a closed environment with the glove bag. Typical procedures associated with glove bags are followed.

Throughout the removal process, air sampling occurs to insure that the glove bag is isolating the insulation particles. In most cases, background sampling occurs prior to commencement of the removal of the insulation to provide a base line for comparison with air sampling during the removal process. The work on the removal can be discontinued if increases in fiber contamination occurs.

It can also be appreciated that the insulation of the boiler wall to which the glove bag is attached, must be in good condition. Once the portion to be removed has been stripped from the boiler wall, a sealant is applied along the exposed interior edge of the remaining asbestos insulation to effectively seal this edge. As can be appreciated, the glove bag requires some support illustrated as 12 to maintain the integrity of the seals of the glove bag to the boiler wall.

In a typical application, the following equipment and supplies are necessary.

a proper size glove bag;

a pair of hooded disposable coveralls;

approved face mask with approved cartridges;

asbestos warning ribbon and signs;

garden type pump spray or other apparatus for spraying of the asbestos;

amended water;

duct tape;

6 ml labelled disposal bags;

wire brush and scraper;

utility knife and wire cutter;

sealant for sealing the exposed asbestos insulation;

HEPA vacuum;

tin snips;

water absorbent such as a rag;

chisel and hammer (required).

The job site should be cordoned off using the asbestos warning ribbon and sign. The workers put on the disposable coveralls and respirators.

The tools are placed in the glove bag and a portion of the boiler wall, including the area to be removed is cleaned with the HEPA vacuum. Spray glue or other suitable adhesive is applied to secure the glove bag onto the wall and provides a good seal between the glove bag and the wall. A tape seal or alternate seal, is provided between the outer edge of the glove bag and the boiler wall. A platform or bench is provided to support the bottom of the glove bag as necessary. In addition, a plastic drop sheet is positioned beneath the glove bag. Before any work to remove the asbestos is commenced, the glove bag and its securement to the wall is inspected for a tight seal.

The portion of the asbestos insulation to be removed and a border area thereabout is wetted with water or amended water. Excess water will drain into the bottom of the bag. Water absorbent material can be placed on the wall above the lower seal to protect the seal.

A utility knife is used to penetrate the asbestos insulation and mark the wall area that needs to be removed. Any metal mesh lathe embedded in the insulation is cut using tin snips or wire cutters. The asbestos insulation is removed in a systematic fashion and carefully placed in the bottom of the glove bag. The insulation, including the removed insulation, is continually wetted to reduce airborne fiber.

After the insulation has been removed, the exposed metal of the boiler wall is cleaned and scraped typically, using a wire brush. A sealant is applied to the exposed insulation and the metal surface. The wall area within the glove bag is cleaned by a wet rag in any suitable manner.

The various tools are cleaned as well as possible within the glove bag and are subsequently removed. The tools may be placed inside one of the gloves which has been pulled to be inside out. The glove with the tools at the end thereof, is then twisted to form a pouch, and the pouch sealed with duct tape. The seal is then cut to remove the pouch as a sealed part of the glove and the portion of the glove bag which remains is also sealed by the duct tape. The glove with the tools therein is opened under water and the tools are then subsequently removed and cleaned.

The HEPA vacuum is then used to clean the head space of the glove bag.

The asbestos is removed by twisting the bottom of the glove bag to form a sac and sealing the sac with the duct tape and cutting the sac from the glove bag through the duct tape. This results in the portion being removed and sealed, as well as the portion that remains on the wall. The seal between the glove bag and the boiler wall is maintained as the glove bag is cut interior to this seal. The HEPA vacuum is then used to clean the work area and pick up any asbestos material trapped behind the remaining portion of the glove bag at the seal. The boiler wall is then inspected to confirm that any remaining asbestos is firmly attached.

The disposable coveralls are then removed and placed in a further waste bag. The respirator cartridges are also placed in the waste bag. All bagged asbestos material is placed in an asbestos waste bin. The workers then wash their hands, face and respirator face plate.

It has been found that this particular method is very time efficient and a substantial time saving is realized relative to the prior practice of building an enclosure about the boiler and the workers operating within this closed environment. The method is also easier for the workers and involves less risk.

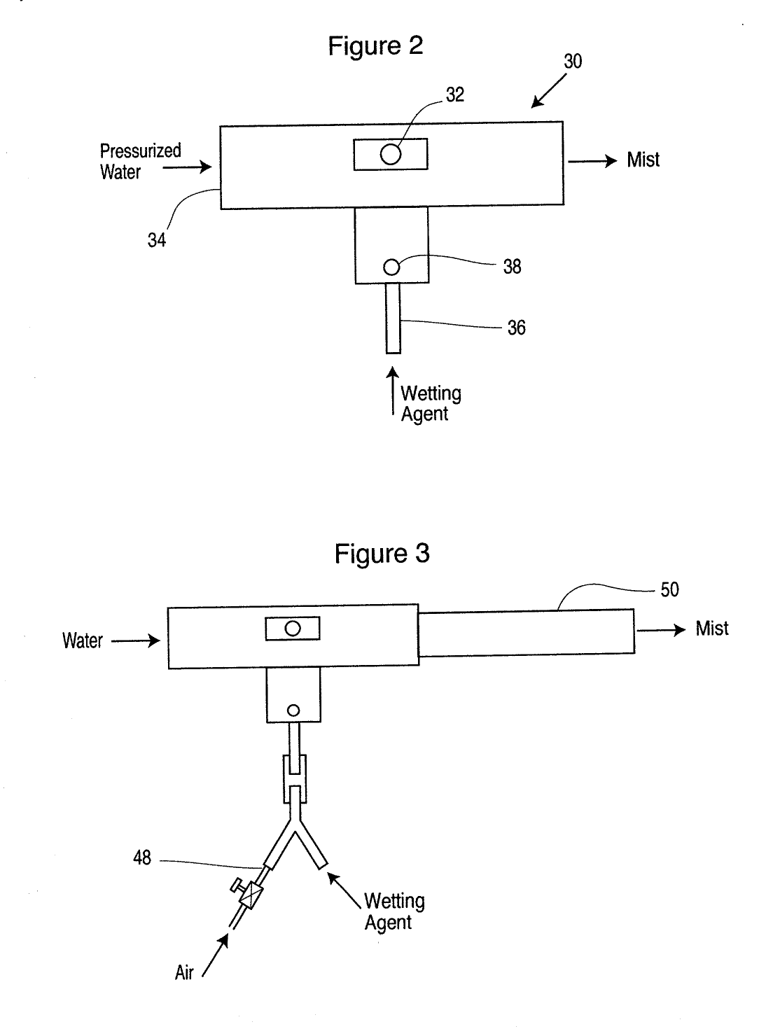

FIG. 2 shows a chemical injector 30 for combining a wetting agent drawn in through inlet 36 with a pressurized water source introduced through inlet 34. The water flow includes an adjustment control 32 and the wetting agent includes an adjustment control 38. With this arrangement, the wetting agent is added in proper proportion to the water and mixed therewith. Thus, the wetting agent is automatically mixed with the pressurized water as necessary.

FIG. 3 shows a modification of the injection arrangement where in addition to the wetting agent being introduced through inlet 36, a small amount of air can be added at 48 with a suitable control valve for varying the amount of air. The addition of a small amount of air assists in breaking up the spray into fine particles. It has been found with either of the arrangements of FIG. 2 or 3, that a more consistent wetting agent concentration is provided and this insures that the minimum amount of water is used inside either the glove bag or inside a hoarding, used to block off a larger structure. This process has particular advantage with respect to larger removals but are also applicable to the glove bag application. The injection arrangement of FIG. 3 includes an elongate static mixer 50 which assists in mixing the wetting agent air and water to provide an effective solution. Other arrangements and nozzles can be used.

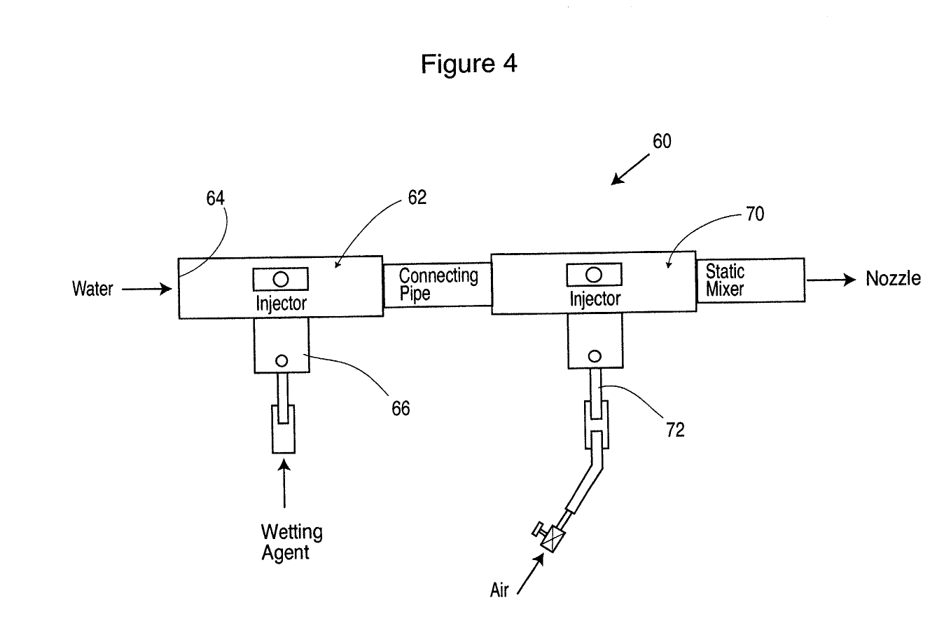

The modified injection arrangement of FIG. 4 includes a first injector 62 which receives through inlet 64, pressurized water, and a wetting agent is drawn through inlet 66. The wetting agent is relatively heavy, thus the full power of the pressurized water is used to introduce the wetting agent. A second injector 70 is used to introduce a small amount of air through inlet 72 into the combined water and wetting agent.

A static mixer 74 encourages mixing of the components. The pressurized liquid and gas are fed to a nozzle for spray application of the asbestos insulation. The various mixing arrangements are simple and easy to use, and significantly reduce the required water normally used for reducing airborne contaminants.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A method of removing a portion of insulation of an insulated wall comprising the steps of
placing tools within a glove bag having a large open mouth,
securing the glove bag to the insulated wall such that the open mouth is attached to the wall and surrounds and is spaced outwardly of the periphery of the portion of insulated to be removed,
wetting the portion of the insulated wall to be removed,
cutting and removing the portion of the insulation wall such that the removed insulation is located in a lower part of said bag,
sealing any exposed edges of the remaining insulation,
cleaning the area of the insulated wall within the mouth to reduce any loose insulation material due to the removal of the portion,
sealing the glove bag below the mouth and cut the bag to free the sealed portion of the bag for further processing, and
removing the remaining portion of the glove bag from the insulated wall.

2. A method as claimed in claim 1 including the steps of pulling one of the gloves inside out and placing any tools therein and sealing the inside out glove to isolate said tools in said glove below the seal and cutting through the seal maintaining the seal on the glove and on the portion of the bag that remains.

3. A method as claimed in claim 1 locating a water absorbent material within said bag above a lower seal of the glove bag to the wall to protect and maintain the integrity of the lower seal.

4. A method as claimed in claim 1 wherein said bag is sealed to said insulated wall by an adhesive adhering said bag to said wall and tape on the outside of the bag at said mouth in contact with said wall to provide an outside seal of said bag to said wall.

5. A method as claimed in claim 1 wherein said insulated wall is made of asbestos.

6. A method as claimed in claim 1 including using an injection arrangement to mix water and a wetting agent which mixture is used to wet the insulation material.

7. A method as claimed in claim 1 wherein said step of securing said glove bag includes adhesively securing the mouth of the glove to the insulated wall.

8. A method as claimed in claim 7 including using a tape to provide a seal at the mouth of the glove bag by securing the tape to the mouth of the glove bag and the insulated wall to form a tape seal about said mouth and between said mouth and said insulated wall.

9. A method of mixing a wetting agent with water and applying the mixture to a hazardous material comprising:
providing pressured water to an injector arrangement connected to a supply of liquid wetting agent, using the flow of pressurized water to draw the wetting agent into the pressurized water to produce a mixture, and spray, applying the mixture to the surface of hazardous insulation material.

10. A method as claimed in claim 9 wherein prior to applying the mixture, the mixture is forced through a static mixer.
